(19) United States
(12) Patent Application Publication
(10) Pub. No.: US 2017/0197850 A1
(43) Pub. Date: Jul. 13, 2017

(54) Water treatment apparatus

(71) Applicant: Claude L. Hebert, Boucherville (CA)

(72) Inventor: Claude L. Hebert, Boucherville (CA)

(21) Appl. No.: 14/998,464

(22) Filed: Jan. 7, 2016

(51) Int. Cl. C02F 1/48; B03C 1/14

(52) U.S. Cl. CPC C02F 1/481; B03C 1/14; C02F 2303/22

(57) ABSTRACT

A magnetic treatment apparatus comprising an outer housing, a plurality of parallel water conditioning devices mounted within the outer housing, each conditioning device having a cylindrical inner tube, a cylindrical outer tube surrounding the cylindrical inner tube, a fluid path formed between the cylindrical outer tube and cylindrical inner tube, a plurality of helical flights extending through the fluid passageway, a plurality of magnets within the cylindrical inner tube, each having a length equal to a distance between adjacent helical flights, the magnets in the inner tube being magnetically aligned.

### FIELD OF THE INVENTION

The present invention relates to a magnetic treatment apparatus for water and more particularly, relates to an apparatus which is suitable for treating water for different purposes.

### BACKGROUND OF THE INVENTION

The ability to maintain minerals in a colloidal suspension in water is required in certain uses. Thus, for example, in irrigation modern techniques permit the diminishment of the consumption of water and thereby an increase in productivity. The current trend is to provide irrigation drop by drop as it is more efficient and less expensive. In regions which are served by artisan wells, the problem of blockage of the feeders is well known.

In addition to the above, water containing calcium and magnesium calcify rapidly in contact with warm air. One can see the minerals deposit on the leaves of the plants.

It would therefore be desirable to have a method for treating water where the minerals are kept in a colloidal suspension delaying any precipitation.

### SUMMARY OF THE INVENTION

It is an object of the present invention to provide a catalyser which helps to maintain the colloidal suspension of calcium and magnesium in water.

According to one aspect of the present invention, there is provided a magnetic treatment apparatus comprising an outer housing, a plurality of parallel water conditioning devices mounted within the outer housing, each conditioning device comprising a cylindrical inner tube, a cylindrical outer tube surrounding the cylindrical inner tube, a fluid path formed between the cylindrical outer tube and the cylindrical inner tube, a plurality of helical flights extending through the fluid passageway, a plurality of magnets within the cylindrical inner tube, each of the magnets having a length equal to a distance between adjacent helical flights, the magnets in the inner tube being magnetically aligned, and an inlet to the fluid path and an outlet therefrom.

According to a further aspect of the present invention, there is provided a method for maintaining a colloidal suspension in water comprising the step of supplying a magnetic treatment apparatus comprising an outer housing, a plurality of parallel water conditioning devices mounted within the outer housing, each conditioning device comprising a cylindrical inner tube, a cylindrical outer tube surrounding the cylindrical inner tube, a fluid path formed between the cylindrical outer tube and the cylindrical inner tube, a plurality of helical flights extending through the fluid passageway, a plurality of magnets within the cylindrical inner tube, each of the magnets having a length equal to a distance between adjacent helical flights, the magnets in the inner tube being magnetically aligned, an inlet to the fluid path and an outlet therefrom, and passing water through the water conditioning devices.

As noted above, the magnetic treatment apparatus has an outer housing with an entry plenum and an exit plenum. The entry plenum is designed to distribute the incoming water to various conditioning devices mounted within the outer housing. At the other end, the exit plenum connects the output from each of the conditioning devices.

The number of conditioning devices enclosed within the outer housing may vary. Generally, there will be between one and nine such devices. Thus, one could use a single conditioning device although this would be rare as it is simpler in many instances to just use the conditioning device per se without the outer housing. Preferred arrangements would include three, five or seven conditioning devices mounted within the magnetic treatment apparatus. However, the number of conditioning devices may include other numbers.

The conditioning device will have an inner cylindrical tube which is preferably formed of stainless steel and is surrounded by an outer cylindrical tube. Mounted interiorly of the inner cylindrical tube are a plurality of magnets. The magnets are aligned—i.e. they would have a north pole adjacent a south pole of an adjacent magnet.

Surrounding the inner cylindrical tube, as above mentioned, is an outer cylindrical tube which defines a fluid passageway between the inner cylindrical tube and outer cylindrical tube. Mounted within the fluid passageway is a helical flight. As used herein, helical flight or helical flights can refer to the same structure. Thus, there is provided a fluid passageway which is helical in nature due to the helical flight mounted in the area between the inner cylindrical tube and the outer cylindrical tube.

The arrangement is such that the distance between adjacent helical flights is equal to the length of the magnets. In other words, for each turn of the helical path, there is a single magnet. Preferably, the magnets would be between two and four inches in length.

Preferably, the water being treated will have at least 50 ppm mineral salts therein. More preferably, the water treated will have between 50 and 1,000 ppm mineral salts.

The conditioning devices are preferably formed of stainless steel. The type of stainless steel may vary depending upon the use of the water being treated.

### BRIEF DESCRIPTION OF THE DRAWINGS

Having thus generally described the invention, reference will be made to the accompanying drawings illustrating embodiments thereof, in which:

FIG. 1 is a perspective view of a magnetic treatment apparatus according to the present invention;

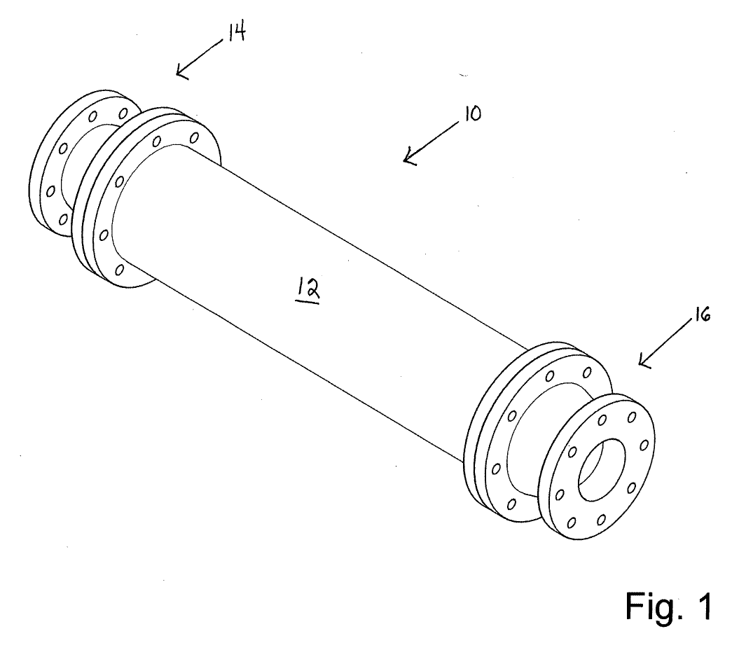

FIG. 1A is an exploded view thereof;

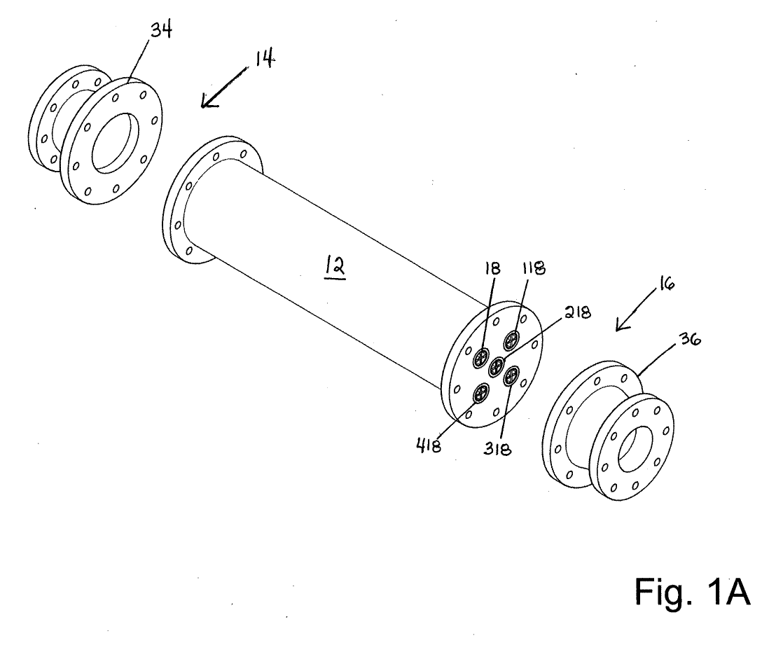

FIG. 2 is a longitudinal cross-sectional view thereof;

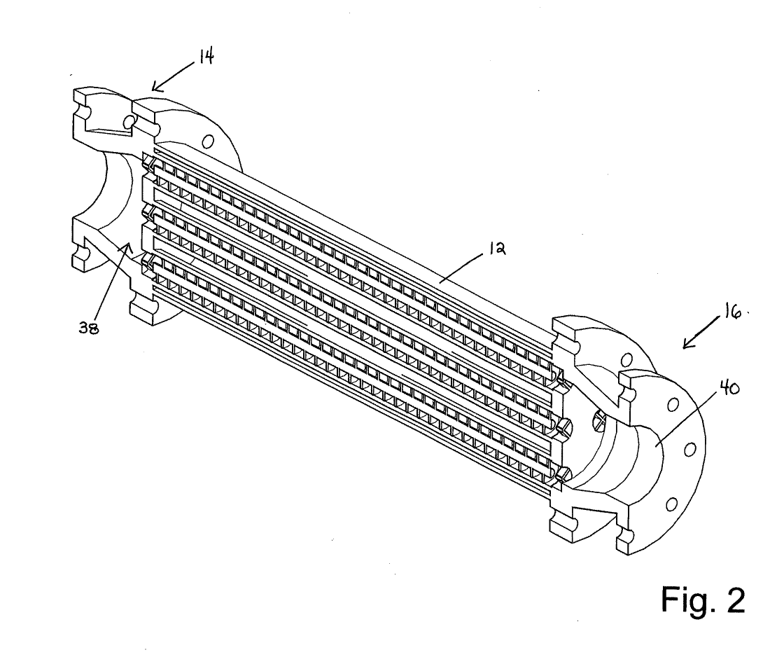

FIG. 2A is a longitudinal sectional view of the central portion of the magnetic treatment apparatus;

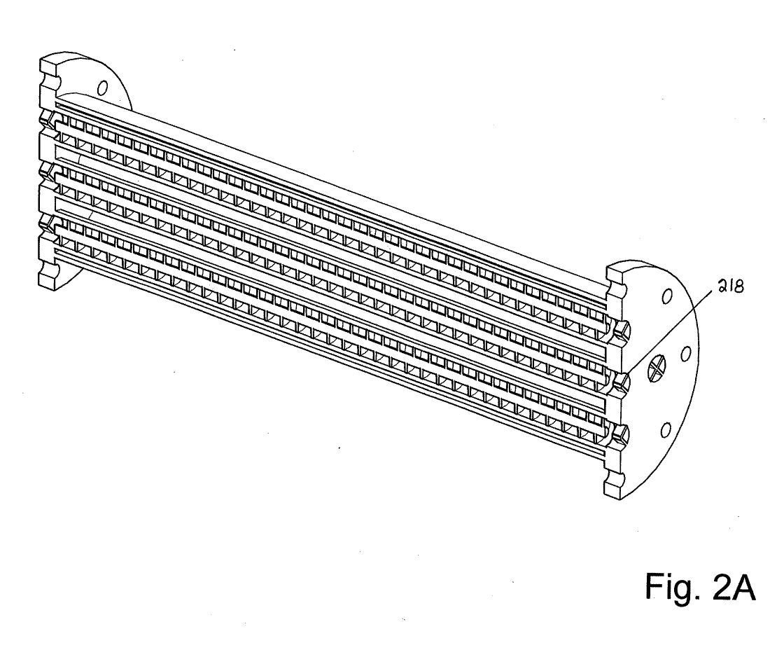

FIG. 3 is an end elevational view of the input end;

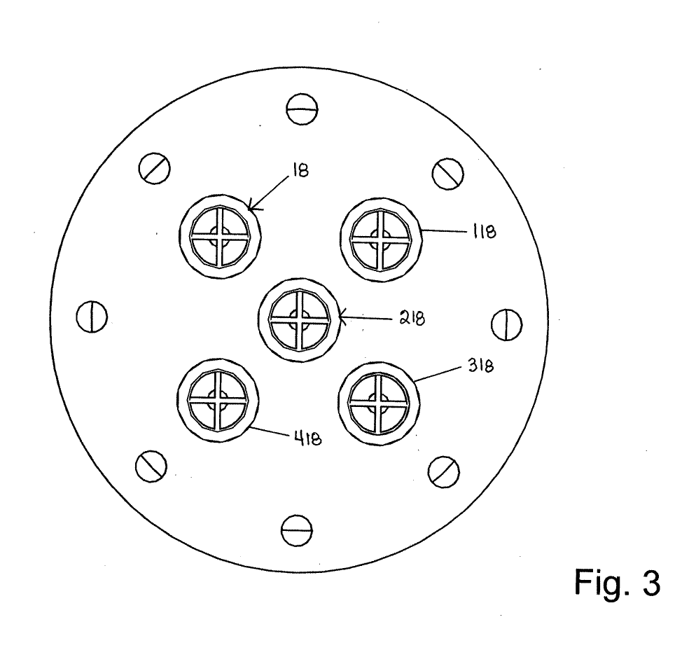

FIG. 4 is an end elevational view of the outlet end thereof;

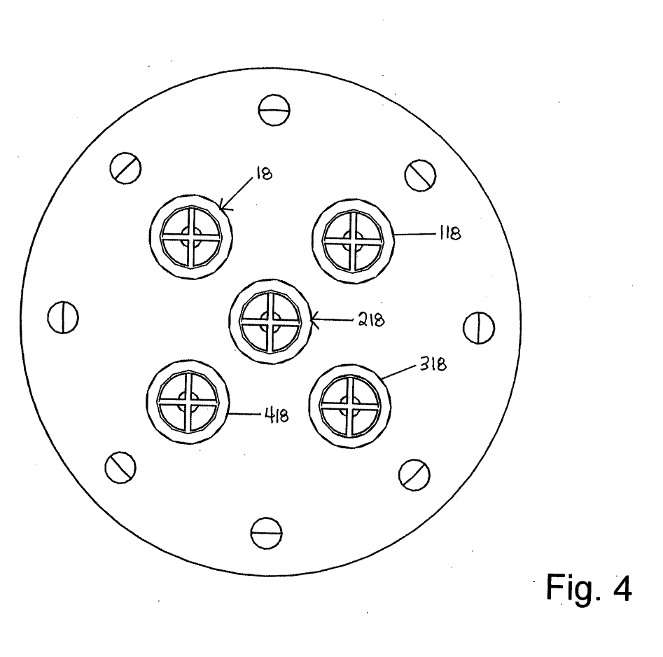

FIG. 5 is a longitudinal sectional view of the cylindrical outer tube;

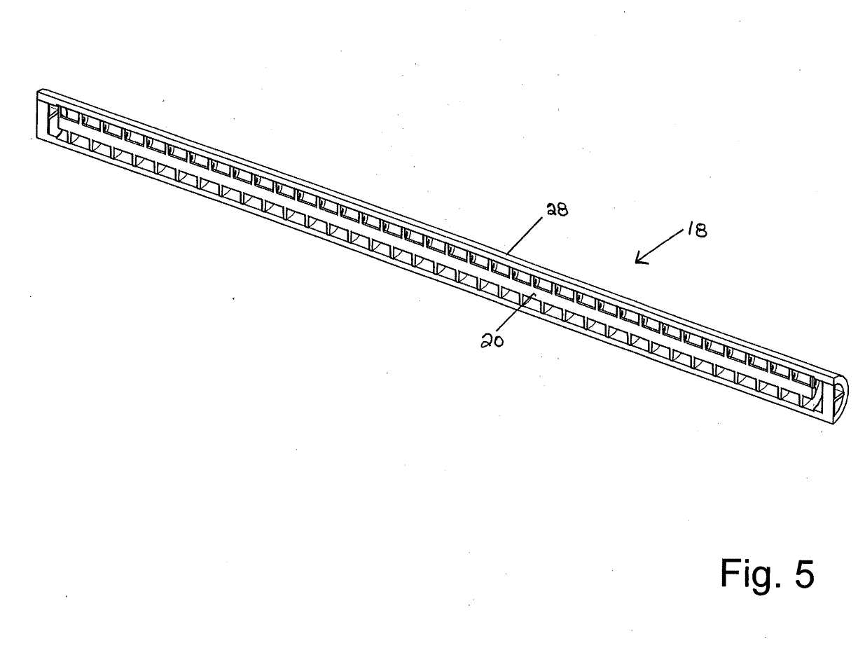

FIG. 5A is a longitudinal sectional view of the cylindrical outer tube with the helical flights thereabout;

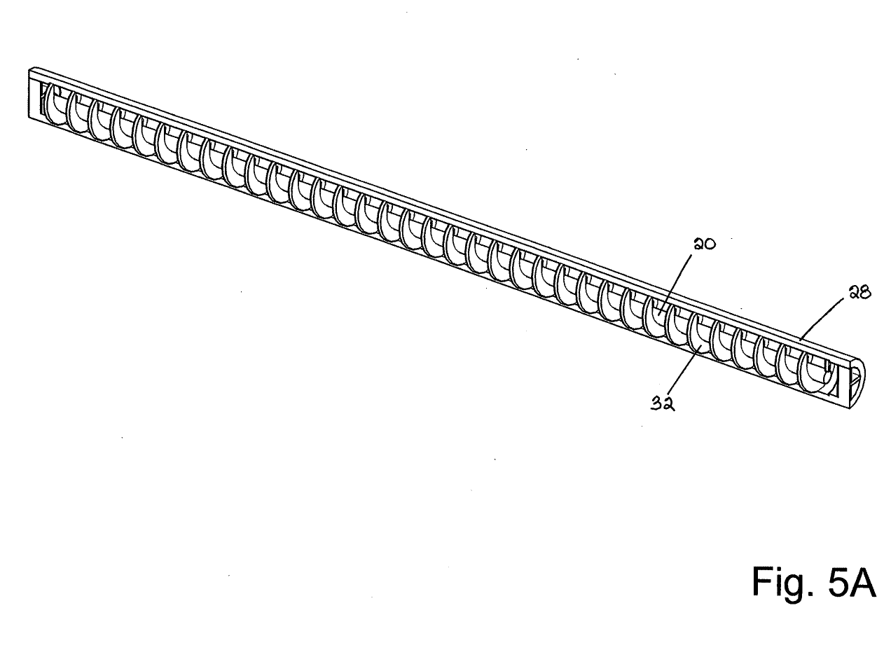

FIG. 6 is a longitudinal sectional view of one of the conditioning devices; and

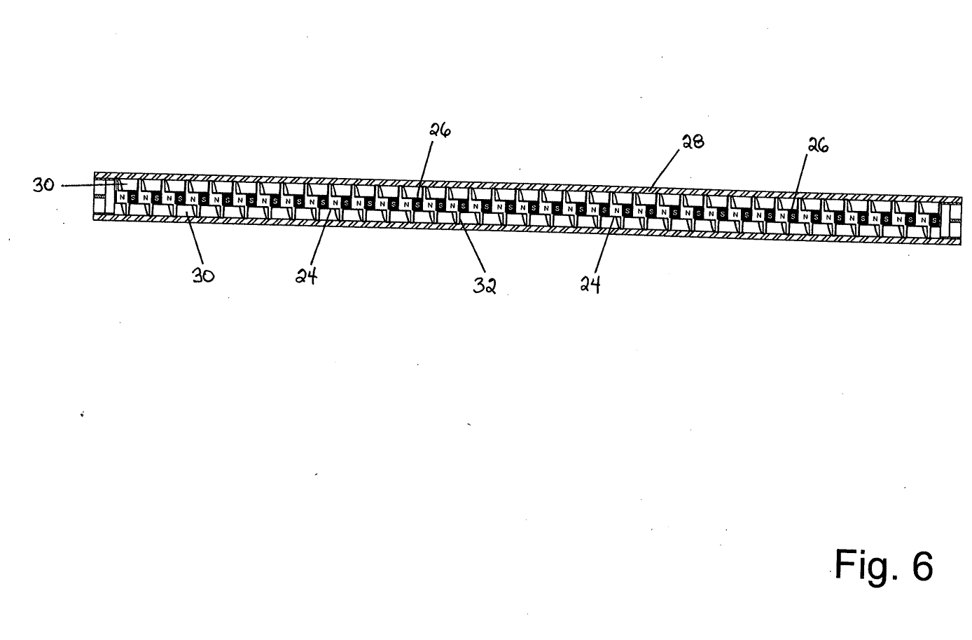

FIG. 7 is a perspective view of the cylindrical inner tube.

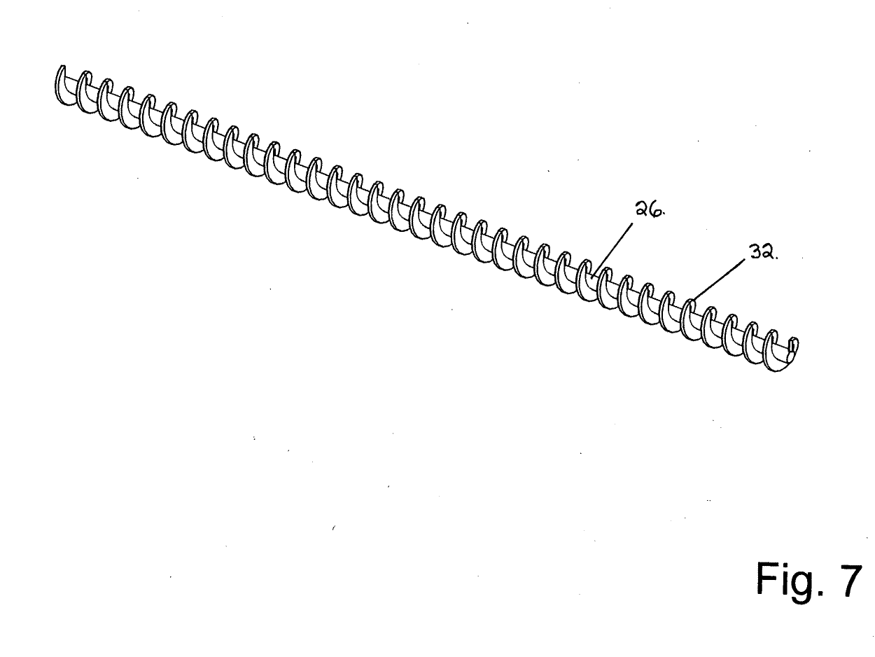

### DETAILED DESCRIPTION OF THE INVENTION

Referring to the drawings in greater detail and by reference characters thereto, there is illustrated a magnetic treatment apparatus which is generally designated by reference numeral 10.

Magnetic treatment apparatus 10 includes an outer housing 12, an inlet end generally designated by reference numeral 14, and an outlet end generally designated by reference numeral 16. Mounted interiorly of outer housing 12 are a plurality of conditioning devices 18, 118, 218, 318 and 418. In the illustrated embodiment, there are provided five such conditioning devices; it will be understood that more or less may be provided. Preferably, there are provided either three, five, seven or nine such devices within an outer housing 12.

Each conditioning device 18, 118, 218, 318 and 418 is substantially identical and thus, only one such device will be described in detail herein.

Conditioning device 18 has an inner cylindrical tube 20. Inner cylindrical tube 20 is preferably formed of stainless steel. Mounted interiorly of inner cylindrical tube 20 are a plurality of magnets 22. Each magnet 22 has a north pole 24 and a south pole 26. It will be noted that magnets 22 are magnetically aligned with a consistent north south-north-south arrangement.

Surrounding inner cylindrical tube 20 is an outer cylindrical tube 28 which is concentric therewith. Formed between outer cylindrical tube 28 and inner cylindrical tube 20 is a fluid path generally designated by reference numeral 30.

Mounted in fluid path 30 are helical flights 32. In this respect, helical flights 32 comprise a single helix which extends within fluid path 30 and is preferably secured to inner cylindrical tube 20. It will of course be recognized that other arrangements for helical flights 32 may be utilized.

Helical flights 32 are arranged such that a distance between each adjacent thereof flights is equal to the length of magnets 22.

Outer housing 12 is provided with a pair of end caps 34 and 36 at inlet end 14 and outlet end 16 respectively. A plenum 38 is provided at inlet end 14 and a plenum 40 is provided at outlet end 16. Plenum 38 provides for the distribution of the fluid to be treated through conditioning devices 18, 118, 218, 318 and 418 while plenum 40 collects the output therefrom.

It will be understood that the above described embodiment is for purposes of illustration only and that changes and modifications may be made thereto without departing from the spirit and scope of the invention.

I claim:

1. A magnetic treatment apparatus comprising:
an outer housing;
a plurality of parallel water conditioning devices mounted within said outer housing, each conditioning device comprising:
a cylindrical inner tube;
a cylindrical outer tube surrounding said cylindrical inner tube, a fluid path formed between said cylindrical outer tube and said cylindrical inner tube;
a plurality of helical flights extending through said fluid passageway;
a plurality of magnets within said cylindrical inner tube, each of said magnets having a length equal to a distance between adjacent helical flights;
said magnets in said inner tube being magnetically aligned; and
an inlet to said fluid path and an outlet therefrom.

2. The magnetic treatment apparatus of claim 1 wherein each of said magnets has a length of between 2″ and 4″.

3. The magnetic treatment apparatus of claim 1 wherein each of said magnets has a field strength of at least 10,000 Gauss.

4. The magnetic treatment apparatus of claim 1 wherein said conditioning devices are formed of a stainless steel material.

5. The magnetic treatment apparatus of claim 1 wherein said outer housing is formed of a mild steel.

6. The magnetic treatment apparatus of claim 1 wherein there are between 3 and 9 conditioning devices mounted within said outer housing.

7. The magnetic treatment apparatus of claim 1 wherein said inner tube and said helical flights comprise a screw, said screw having a pitch equal to the length of each of said magnets.

8. A method for maintaining a colloidal suspension in water comprising the step of supplying a magnetic treatment apparatus comprising:
an outer housing;
a plurality of parallel water conditioning devices mounted within said outer housing, each conditioning device comprising:
a cylindrical inner tube;
a cylindrical outer tube surrounding said cylindrical inner tube, a fluid path formed between said cylindrical outer tube and said cylindrical inner tube;
a plurality of helical flights extending through said fluid passageway;
a plurality of magnets within said cylindrical inner tube, each of said magnets having a length equal to a distance between adjacent helical flights;
said magnets in said inner tube being magnetically aligned;
an inlet to said fluid path and an outlet therefrom; and
passing water through said water conditioning devices.

9. The method of claim 8 wherein said water has at least 50 ppm mineral salts.

10. The method of claim 9 wherein said water has between 50 and 1,000 ppm of mineral salts.
